(19) United States
(12) Patent Application Publication
(10) Pub. No.: US 2022/0083320 A1
(43) Pub. Date: Mar. 17, 2022

(54) MAINTENANCE OF COMPUTING DEVICES

(71) Applicant: Hewlett-Packard Development Company, L.P., Spring, TX (US)

(72) Inventors: Helen Balinsky, Bristol (GB); Grady Cooper, Boise, ID (US); Daniel Cameron Ellam, Bristol (GB)

(73) Assignee: Hewlett-Packard Development Company, L.P., Spring, TX (US)

(21) Appl. No.: 17/420,047

(22) PCT Filed: Jan. 9, 2019
(86) PCT No.: PCT/US2019/012915

§ 371 Date: Jun. 30, 2021

(51) Int. Cl. G06F 8/41; G06F 11/36; G06N 20/20; G06N 20/10

(52) U.S. Cl. CPC G06F 8/41; G06N 20/10; G06N 20/20; G06F 11/3628

(57) ABSTRACT

In an example there is provided a method to access data records generated by a computing device, the data records specifying at least an event log of in-device code executed by the computing device. The method comprises applying pattern recognition to the data records of the computing device to determine if the computing device needs in-device code maintenance and performing maintenance of the in-device code on the computing device in response to the output of the pattern recognition.

### BACKGROUND

Modern computing devices comprise a large number of hardware and software components. Devices often have software which is referred to as firmware that is installed by the manufacturer or a third party. Hardware and software on devices need maintenance over time. This may be due to corruption by malware or simply because the device is becoming outdated. In contrast to hardware issues, maintenance of firmware may be performed remotely and at a low cost.

### BRIEF DESCRIPTION OF THE DRAWINGS

Various features of certain examples will be apparent from the detailed description which follows, taken in conjunction with the accompanying drawings, which together illustrate, by way of example only, a number of features, wherein:

FIG. 1 shows an apparatus according to an example.

FIG. 2 shows a block diagram of a method according to an example.

FIG. 3 shows a processor associated with a memory and comprising instructions for performing maintenance of firmware on a computing device.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Modern consumer devices such as personal computers and printing devices have numerous pieces of software also known as “firmware” written in to memory. Firmware may be placed on a device by the manufacturer or by a third party. Sometimes firmware becomes corrupted due to malicious software on the device or as a result of a bug. Firmware failure can be a frustrating experience for consumer and device manufacturers. For consumers, firmware failure can lead to down time when their device is no longer operation. Moreover, due to lack of technical knowledge, firmware failure is often mistaken for hardware failure by consumers. This can lead to consumers making unnecessary calls to customer support lines and requesting callouts for engineers to fix problems which could easily be fixed with a firmware upgrade. In the worst cases this leads to fully functional hardware being sent back to the manufacturer for repair.

From a manufacturer's perspective, many straightforward problems could be resolved with a simple firmware upgrade without requiring further assistance from the manufacturer. For networked devices, it is often possible to upgrade firmware remotely by either having the device communicate to a remote server that a firmware upgrade is may be needed, or by pushing a firmware upgrade on to the device from the remote server. Many problems could be alleviated cheaply and efficiently in this manner if it were possible to pre-empt firmware failures at an early stage. Moreover, in the case of malware infections, it is advantageous to identify the problems at an early stage, since the longer the malware is operating on the device, the more likely it is that the malware will spread to other devices in communication with the infected device.

To enable early and pre-emptive detection, it is useful to be able to identify which events lead to a firmware failure in comparison to those events on the device which lead to more general failure such as a hardware failure or a combination of hardware and firmware failure. For example, it may be the case that a certain subsection of the disk becomes corrupted. In this case, it may be necessary to replace the disk rather than merely upgrade the firmware.

Machine learning combines techniques from data mining and computational statistics to construct predictive models. Machine learning techniques use pattern recognition to identify which of a set of categories (sub-populations) a new observation belongs. The process of classifying the new observation is made on the basis of a training set of data containing observations whose category membership is known. Analysis of historic data can reveal deep relationships within data which leads to more accurate predictions and improved classification over simplistic extrapolation techniques.

The methods and systems described herein use machine learning in combination with other data analytics techniques to determine if a device is likely to suffer an in-device code failure. According to examples “in-device code” may be firmware. In other cases in-device code may be software installed following an update on a device. According to examples described herein, a pattern recognition classifier is trained on historic data records of computing devices. Pattern recognition is used to identify patterns in data sets. In particular, patterns of events in the event logs of in-device code on computing devices are analysed to determine events which are more likely to lead to in-device code failure. In the case where it is determined that a certain pattern of events is occurring on a device, the in-device code on the device may be upgraded or reinstalled, for example.

To identify those events which are likely to lead to in-device code failure, it is helpful to first analyse the historic maintenance records of the devices. According to an example, a database of maintenance records is maintained. An issue that occurs on a computing device requiring an engineer to go on site to fix it, is logged into the database. This includes text the engineer entered in the form of a “repair note” to describe how the issue was fixed. In addition, information on parts replaced by the engineer during the callout are recorded. In-device code failures are predicted by combining this information with events in the event logs and/or telemetry of the computing device.

Engineer repair notes may comprise unstructured text provided by the engineer which reflect actions taken to repair the device. According to examples described herein, criteria for determining when an engineer's fix simply involved the in-device code are distinguished amongst all the repair notes. Since engineer repair notes are often highly unstructured, false positives which include mixed in-device code and hardware maintenance may accidentally be identified as in-device code maintenance and vice-versa, in the case of false negative identifications.

Multiple criteria for distinguishing in-device code repair events from the rest of the repair notes which may include, for example, part replacements, may be provided by a domain expert. The rules include combinations of keywords corresponding to each set, for example, “FW”, “firmware”, “upgrade”, and others. In addition, repairs which did not involve any physical parts being replaced are also potentially in-device code upgrades. In another case, in-device code repair events may be identified by looking at the telemetry or other logs from the device to see if an in-device code upgrade occurred in close temporal proximity to the maintenance of the device.

Multiple labelled sets, corresponding to different types of repair events, such as “disk repair”, “cartridge replacement”, “firmware upgrade”, “FW upgrade”, “FW repair” and others are created. Techniques such as feature extraction and regular expression matching are then used to classify maintenance events on computing devices into in-device code events and non-in-device code related events. In certain examples the data sets may not contain information directly relating to whether there was an in-device code repair performed. In these cases, an alternative is to deduce this from the data collected. For instance, rules may be used in conjunction with an neurolinguistic processing system to classify the maintenance that took place on devices.

Once those in-device code maintenance events are identified, the next stage is to try and predict those events in the event logs and/or telemetry of the computing device which are likely to lead to an in-device code failure and subsequent maintenance.

Both maintenance records and event logs uniquely identify computing devices by their serial number. When the timestamps in both are reasonably synchronized, data can be extracted from event logs preceding in-device code repair. This allows a correlation between engineers' notes and event logs/telemetry to be determined to see if notable changes in the telemetry appear in a short time period before an in-device code issue occurs.

According to an example, data sets are mined to test the hypothesis that in-device code failure can be predicted using computing device event logs. To this end a new data set from the raw telemetry/event logs, and engineer note database is constructed using a rolling window over a time period. According to examples, the time period may be 30 days. Events that happen within the window are captured and recorded.

A new data set is created which comprises an event log vector. A determination of whether events in the window lead to an in-device code repair or not is made. If an in-device code repair is made at the end of the window, the data point is labelled with a 1. Otherwise, it is labelled with a 0. The process is repeated over a large number of computing devices using the associated historical data.

Having generated the dataset, the hypothesis of whether certain events and/or combinations of events in the window became unusually common leading up to an in-device code repair at the end of the window, is tested. This may be confirmed, for example, by evaluating the statistical significance of events leading to in-device code events e.g. using z-tests.

In the final stage, and assuming the hypothesis is confirmed with respect to events in the event logs of the computing devices, the event logs of a new device, which previously haven't been analysed can be evaluated to determine if an in-device code upgrade is needed.

According to examples described herein, simple checks on certain events appearing in the lead up to a failure may or may not be sufficient to avoid miscategorising a sequence of events as likely leading to an in-device code failure. Indeed, the cost of misidentification may be very high, if the computing device hardware subsequently fails. According to examples described herein one or more machine learning techniques may be used to establish whether deeper trends exist within the event logs, to pre-empt in-device code failure on the device.

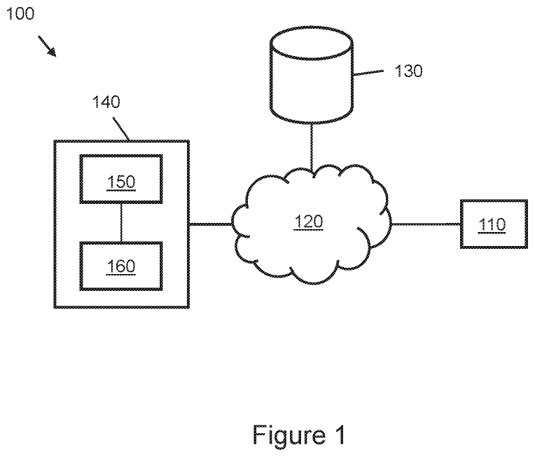

FIG. 1 shows an apparatus 100 according to an example. In FIG. 1 there is shown a computing device 110. The computing device 110 may be, according to examples, a personal computer (PC) or a networked device such as a printing device. The computing device 110 comprises a memory (not shown in FIG. 1). The memory may store executable instructions in the form of in-device code or “firmware”. During normal operation, the memory is accessed by the computing device 110 and the in-device code is executed. In the example apparatus 100 shown in FIG. 1 the computing device 110 is a networked device connected to a network 120. According to examples, the network is the internet, or a local area network (LAN).

In FIG. 1 there is shown a data storage 130 which is also connected to the network 120. In examples described herein, the data storage is arranged to store data records of computing devices connected to the network 120. The data records specify at least event logs of in-device code executed by the computing devices connected to the network 120. The event logs comprise a record of all events related to the in-device code that is executed on the computing device 110.

In the example shown in FIG. 1, the data storage container 130 is shown as a separate entity remote from the computing device 110. In other cases, the data storage 130 is coupled directly to the computing device 110. In further examples, the computing device 110 is arranged to record and store its own data records.

According to examples described herein the apparatus 100 shown in FIG. 1 comprises a system 140. The system 140 is coupled to the network 120 and is arranged to perform classification to determine whether in-device code on the computing device 110 needs maintenance. In FIG. 1 the system 140 is shown as a physical entity, however the system 140 may be executed in just software or a mix of software and hardware on a device. In the present context software comprises instruction on a non-transitory machine readable medium.

The system 140 comprises a classification module 150. The classification module 150 is arranged to access data records of the computing device 110 stored on the data storage 130 via network 120. In examples described herein the classification module 150 is arranged to apply pattern recognition to the data records of computing devices to determine if the computing devices needs in-device code maintenance.

The system 140 further comprises an in-device code maintenance module 160. The in-device code maintenance module 160 is communicatively coupled to the classification module 150. In examples described herein the in-device code maintenance module 160 is arranged to perform maintenance of the in-device code on the computing device 110 in response to the output of the pattern recognition. In particular, if there is a positive determination by the classification module 150 that the in-device code executing on the computing device 110 needs maintenance then the in-device code maintenance module 160 is arranged to perform maintenance. In certain examples, the maintenance of in-device code may comprise an in-device code upgrade or downgrade.

In some cases, the in-device code may be fully or partially reinstalled on the device following a positive determination that maintenance is needed. The computing device 110 is arranged to execute instructions to perform maintenance of the in-device code in response to communication with the system 140.

According to examples described herein, the system 140 comprises a training module (not shown in FIG. 1). The training module is arranged to access event logs stored in the data storage 130, for a subset of computing devices that are in communication with the network 120. The training module is further arranged to access data for the maintenance history of the computing devices. According to examples, maintenance history may comprise maintenance logs that relate to software and/or hardware on the computing device.

The training module is arranged to evaluate the event logs and maintenance history for the subset of computing devices and construct pattern recognition to predict the likelihood that a computing device will need in-device code maintenance on the basis of the evaluation of the event logs. Pattern recognition may then be used by the classification module 150 to determine if further computing devices which connect to the network will need in-device code maintenance on the basis of their event logs.

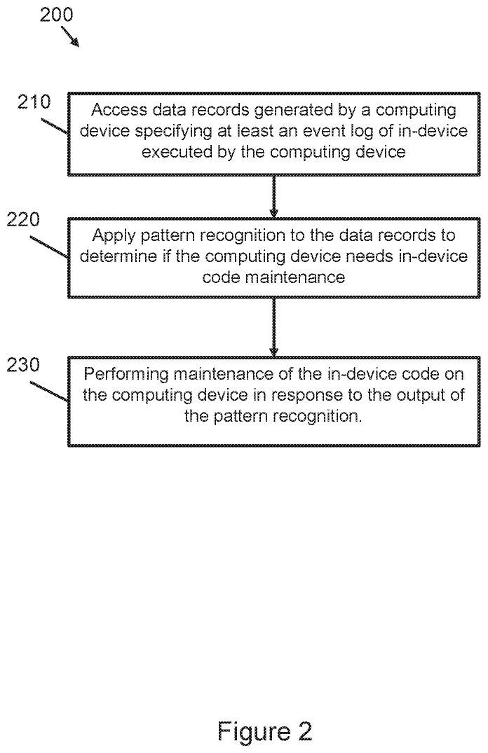

FIG. 2 is a flow diagram showing a method 200 of determining whether a computing device needs in-device code maintenance according to an example. According to an example, the method 200 is implemented on the apparatus 100 shown in FIG. 1. At block 210 data records for a computing device specifying at least an event log of in-device code executed by the computing device, are accessed.

When the method 200 is implemented in conjunction with the apparatus 100 shown in FIG. 1 block 210 is implemented on the system 140. According to examples, the classification module 150 of the system 140 implements block 210.

At block 220 pattern recognition is applied to the data records to determine if the computing device needs in-device code maintenance. In accordance with examples described herein, the classification module 150 may be arranged to perform this block. At block 230 maintenance is performed on the in-device code of the computing device in response to the output of the pattern recognition.

In certain examples described herein pattern recognition may be performed by a classifier, a neural network, ensemble learning, a recurrent neural network or sequential data analyser. In the present context a classifier is a statistical algorithm used to classify data into two or more groups. A sequential data analyser is an algorithm which is used to identify patterns in data based on an analysis of data in a sequential fashion in which the sample size is not fixed in advance.

In certain examples described herein, application of pattern recognition at block 220 may be applied by the computing device itself. For example, in certain cases, the system 110 shown in FIG. 1 may be implemented on the computing device 110 itself, in which case the classification may be performed on the computing device. In a further example, the method comprises sending, in response to determining that the in-device code needs maintenance, a request to a remote server to perform in-device code maintenance on the computing device. For example, in the case that a determination is made by pattern recognition that the in-device code needs maintenance, the computing device 110 shown in FIG. 1 can send a request to the system 110 requesting in-device code maintenance is performed.

In further examples of the method 200, the method may further comprise applying pattern recognition at a remote server. For example, when the method 200 is implemented on the apparatus 100 shown in FIG. 1, in certain cases, the system 140 is implemented in a remote server. In such cases the classification of the computing device 110 into a device which either does or does not need maintenance is performed at a remote server which has access to the event logs of the computing device that are stored in the data storage 130, over network 120.

In one case, the method 200 shown in FIG. 2 performing maintenance of in-device code on the computing device may comprise upgrading or downgrading the in-device code. In other cases, the method 200 may comprise reinstalling existing in-device code in response to a determination that the computing device needs in-device code maintenance. In one case, the method 200 comprises determining which remediation action is needed based on the classification determining that maintenance of in-device code is needed.

According to examples described herein, the method 200 may further comprise accessing maintenance records for a plurality of computing devices, and identifying, from the maintenance records, those maintenance records corresponding to in-device code maintenance on the computing devices. This is performed, in certain examples, by the training module previously described in relation to apparatus 100.

According to examples described herein, event logs for the in-device code on the plurality of embedded devices are accessed and a determination of whether there exists a correlation between in-device code-related events in the event logs over a time period, and the maintenance records of in-device code on respective computing devices is made. If such a correlation exists then pattern recognition based on an evaluation of the event logs is constructed. An example of a pattern recognition process is a process which outputs a 1 in the case that a computing device needs in-device code maintenance and a zero in the case that the in-device code on the computing device does not need maintenance. Machine learning algorithms such as random forests are suitable for pattern recognition.

The methods and systems described herein are used to identify computing devices which needs in-device code maintenance. The methods and systems, in particular, allow an early determination of the likelihood of failure of in-device code on devices. Advantageously this ensures continuity and avoids disruption on devices where problems are mis-identified as hardware related issues. Furthermore, this reduces the amount of computing devices which are unnecessarily returned to the manufacturer when the device could be fixed with a straightforward in-device code upgrade.

Certain methods and systems described herein utilise machine learning to identify deep relationships in the event logs associated to the computing device. The methods described herein may readily be implemented on the computing devices themselves or in the cloud. Advantageously, the methods reduce costs and improves efficiency for the consumer and the device manufacturer. Examples in the present disclosure can be provided as methods, systems or machine-readable instructions, such as any combination of software, hardware, in-device code or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

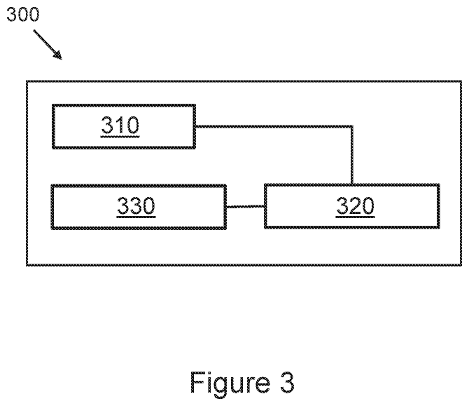

FIG. 3 shows an example of a processor 310 associated with a memory 320. The memory 320 comprises computer readable instructions 330 which are executable by the processor 310. The instructions 330 comprise instruction to, at least access data for an embedded device, the data including at least an event log of firmware executed by the embedded device, classify the data of the embedded device to determine if the embedded device needs firmware maintenance, and perform maintenance of the firmware on the embedded device on the basis of the classification of the data.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
accessing data records generated by a computing device, the data records specifying at least an event log of in-device code executed by the computing device;
applying pattern recognition to the data records of the computing device to determine if the computing device needs in-device code maintenance; and
performing maintenance of the in-device code on the computing device in response to the output of the pattern recognition.

2. The method of claim 1, wherein applying pattern recognition comprises applying a classifier, neural network, a recurrent neural network, ensemble learning, a random forest, a support vector machine or a sequential data analyser.

3. The method of claim 1, comprising applying pattern recognition at the computing device.

4. The method of claim 2, comprising automatically performing code maintenance in the computing device, in response to determining that the in-device code needs maintenance.

5. The method of claim 2, comprising sending, in response to determining that the in-device code needs maintenance, a request to a remote server to perform in-device code maintenance on the computing device.

6. The method of claim 1, comprising applying pattern recognition at a local or remote server.

7. The method according to claim 1, wherein performing maintenance of in device code comprises, installing, reinstalling, upgrading or downgrading the in-device code, resetting to a factory condition, cleaning data and resetting a device configuration.

8. The method of claim 1, comprising:
accessing maintenance records for a plurality of computing devices;
identifying, from the maintenance records, those maintenance records corresponding to in-device code maintenance on the computing devices;
accessing event logs for the in-device code on the plurality of computing devices;
determining a correlation between events in the event logs over a time period, and the maintenance records of in-device code on respective computing devices; and
constructing, a pattern recognition classifier based on an evaluation of the event logs.

9. The method of claim 8, wherein identifying maintenance records of in-device code on the computing devices comprises:
classifying maintenance records in to at least two classes including at least a first class comprising maintenance records that specify in-device code-related maintenance of the computing device.

10. The method of claim 8, wherein determining if a correlation exists between in-device code-related events and maintenance records comprises:
identifying statistically significant in-device code-related events in the event logs of the plurality of the computing devices that precede maintenance of in-device code on respective computing devices.

11. The method of claim 8, wherein constructing a pattern recognition classifier comprises:
training an initial pattern recognition classifier on a subset of the plurality of devices;
optimizing the initial classifier based on a comparison of the accuracy of the output of the initial classifier and the maintenance records of the subset of the plurality of computing devices.

12. An apparatus comprising:
a data storage arranged to store data records of computing devices, the data records specifying at least event logs of in-device software executed by the computing devices;
a classification module arranged to apply pattern recognition to the data records of computing devices to determine if the computing devices needs software maintenance; and
a software maintenance module arranged to perform maintenance of the software on computing devices in response to the output of the pattern recognition.

13. The apparatus of claim 12 comprising:
a training module arranged to:
access event logs for a subset of the computing devices
evaluate the event logs and maintenance history for the subset of computing devices; and
execute pattern recognition to predict the likelihood that a computing device will need in-device code maintenance on the basis of the evaluation of the event logs and maintenance history for the subset of the computing devices.

14. The apparatus of claim 12, wherein the classification module is arranged to classifying data records in to at least two classes including at least a first class comprising data records that specify in-device code-related maintenance of the computing device.

15. A non-transitory machine-readable storage medium encoded with instructions executable by a processor, to:
access data files for an embedded device, the data files including at least telemetry of firmware executed by the embedded device;
classify the data files of the embedded device to determine if the embedded device needs firmware maintenance; and
perform maintenance of the firmware on the embedded device on the basis of the classification of the data files.
